(19) United States
(12) Patent Application Publication
(10) Pub. No.: US 2010/0326684 A1
(43) Pub. Date: Dec. 30, 2010

(54) Road Grader/Spreader System and Method

(76) Inventor: Myron L. Mullett, Westcliffe, CO (US)

Correspondence Address: LAW OFFICE OF DALE B. HALLING, 3595 FOUNTAIN BOULEVARD SUITE A2, COLORADO SPRINGS, CO, 80910, US

(21) Appl. No.: 12/491,415

(22) Filed: Jun. 25, 2009

Related U.S. Application Data
(63) Continuation-in-part of application No. 11/397,399, filed on Apr. 5, 2006, now Pat. No. 7,686,537.

(51) Int. Cl. E02F 3/85; E01C 21/00; E02F 3/815; A01B 35/20; E01C 19/48

(52) U.S. Cl. 172/812; 404/72; 172/815; 172/772; 404/86

(57) ABSTRACT

The present invention is a road grader attachment that attaches to a bulldozer. The attachment has an elongated blade with mutually parallel side members attached to the lateral ends of the blade where each of the side members comprise a pair of spaced apart walls that house a plate movable in an up and down direction within the side member. Each of the movable plates is attached at its lower edge to a ground contacting skid. A hydraulic piston interconnects each side member with its respective interior plate for moving the plate up and down within the side housing member in order to raise or lower the skid that is attached to the movable plate

### RELATED APPLICATIONS

The present invention claims priority on patent application Ser. No. 11/397,399, filed on Apr. 5, 2006, entitled “Road Grader/Spreader” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

The prior art reveals a considerable number of devices designed to spread materials over the ground or over existing layers of material where it is desirable to obtain a finished grade. All of the known apparatus of this kind are towable behind a tractor or similar vehicle. Such a device is disclosed in U.S. Pat. No. 6,308,785 to Rhoden, issued Oct. 30, 2001.

Machines similar to the Rhoden grader/spreader are satisfactory for their intended agricultural purposes but have limitations when applying and spreading materials for road and highway construction. The depth or thickness of layers of gravel and other materials that comprise a road or highway are carefully specified by the design engineers. In many cases the depth requirement is a minimum figure and unintended deposition of a greater amount of material is wasteful and overly expensive. For example, many excess cubic yards of material would be consumed if one inch of material in excess of the specification is applied to a multi-mile roadway thirty feet wide. Failure to maintain a minimum depth of gravel can result in expensive rework. Commonly, the minimum depth for a gravel road is maintained by having a surveying crew place blue tops into the base grade every 60 feet or so. A blue top is a survey or grade stake usually made of plastic with a solid cylinder at one end and a plurality of flexible tails on the second end. Then gravel is placed on the base grade so that the blue tops are covered by the gravel. A road grader then grades the gravel so that the top of the gravel is at the beginning point of the blue tops. Often this takes multiple passes by the road grader. In addition, error can occur in the areas of the road between the blue tops. As a result, considerable time and effort is used to obtain a consistent depth of gravel for a road.

When a grader/spreader is pulled by a vehicle it can be assumed that the towing vehicle is going to traverse surface variations that are going to cause the grader/spreader to undulate in response to the pitching motions of the towing vehicle. Where the work is being done to construct or resurface a road or highway the rising and falling movement of the grader results in an uneven surface on the material being spread, together with significant departures from the design specification. Agricultural endeavors do not require the grader precision that must be present in road and highway work. Previous devices require a survey team to place blue tops along the base grade of a gravel road. The blue tops define the height of the gravel road and have to be accurately placed at spaced intervals requiring an expensive survey crew. The gravel is then placed over the blue tops and a road grader moves the gravel until all of the tail of the blue tops is exposed but not the body. This process takes multiple passes by the grader to be accurate. Also this does not ensure that the depth between the blue tops is accurate. If the level of the gravel between the blue tops is too low, this requires expensive rework. The previous methods of laying a gravel road often place additional gravel on the road to avoid this rework. However, this is wasteful and expensive.

Thus there exists a need for a road grader/spreader that accurately lays down a layer of gravel in a single pass.

### BRIEF SUMMARY OF INVENTION

The present invention is a road grader attachment that attaches to a bulldozer. The attachment has an elongated blade with mutually parallel side members attached to the lateral ends of the blade where each of the side members comprise a pair of spaced apart walls that house a plate movable in an up and down direction within the side member. Each of the movable plates is attached at its lower edge to a ground contacting skid. A hydraulic piston or similar in reciprocating device interconnects each side member with its respective interior plate for moving the plate up and down within the side housing member in order to raise or lower the skid that is attached to the movable plate. Up and down movement of the skids with respect to the side members that are attached to the blade results in selective positioning of each end of the blade so their respective elevations above the grade on which the skid rests will result in a precise depth and slope of the material that is being spread.

### BRIEF DESCRIPTION OF THE SEVERAL VIEWS OF THE DRAWINGS

FIG. 1 is a perspective view of a bulldozer pushing the grader/spreader of the present invention.

FIG. 2A is a rear perspective view of the grader blade of the present invention showing in cross section a fragmentary view of the bulldozer blade that mounts the grader blade. The illustrated left side skid is shown in the retracted position that allows the left end of the grader blade to be at essentially the same level as the skid.

FIG. 2B is a fragmentary perspective view of the grader blade with the illustrated left end of the blade raised above the level of the left side skid.

FIG. 3 is a cross sectional view taken along lines 3-3 in FIG. 2A.

FIG. 4 is a top right perspective view of the front of an expandable grader attachment in accordance with one embodiment of the invention.

FIG. 5 is a top right perspective view of the back of the expandable grader attachment in accordance with one embodiment of the invention.

FIG. 6 is a flow chart of the steps of creating a gravel road in accordance with one embodiment of the invention.

### DETAILED DESCRIPTION OF THE INVENTION

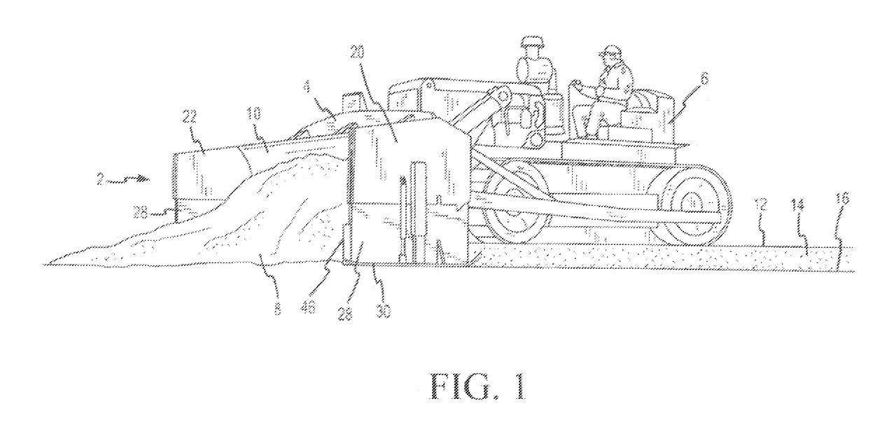

The grader/spreader 2 of the present invention is shown in FIG. 1 as mounted on and carried by the front blade 4 of a bulldozer 6 is spreading gravel 8 to a specified layer depth. Prior to spreading the gravel is piled in front of the blade 10 of the grader/spreader 2. The bulldozer operates on top of the finished grade 12 of the gravel, or other material that is being spread, thereby assuring a level and constantly accurate depth of the layer 14.

The depth of the layer 14 above the base grade 16 is controlled by the elevation of the bottom edge of the blade 10 above the base grade. The elevation of each lateral end of the blade 10 may be independently set by hydraulic controls in the cockpit of the bulldozer. This selective adjustment of the height of the blade allows the grade to be sloped from right to left or left to right, or with equal height of each blade end resulting in a level grade.

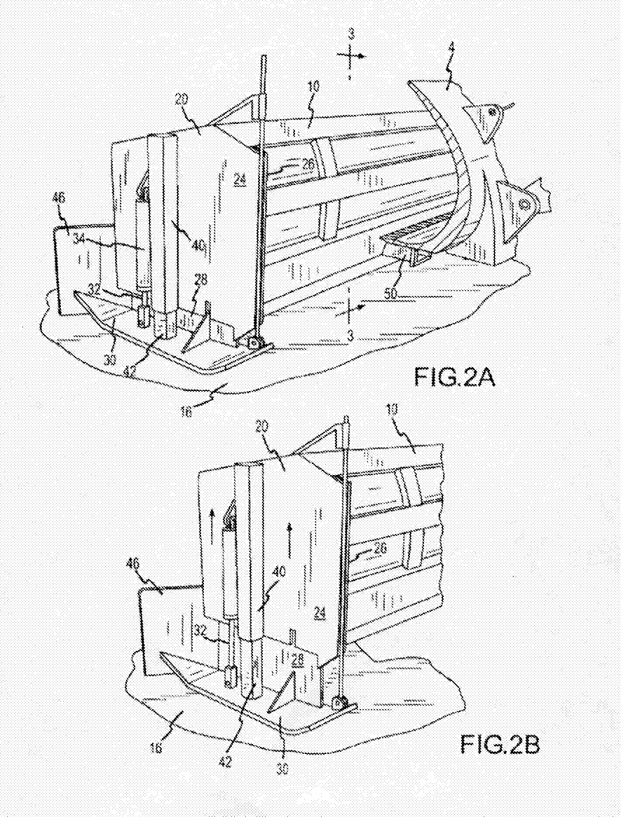

The novel apparatus for selective adjustment of the height of the blade ends is illustrated in FIGS. 2A and 2B. To the lateral ends of the grader blade 10 there are attached side members 20 and 22. Each of the side members includes a pair of spaced apart steel panels 24 and 26 between which is disposed a plate 28 that is slidable in an up and down direction. The bottom edge of the plate 28 is secured to a flat skid 30 that is adapted to run along the base grade 18 of the roadway being worked on. To provide the force necessary to slide the plate 28 between the panels comprising each of the end members and thus raise or lower the skid 30, a hydraulic piston 32 is provided. One end of the piston is attached to the skid 30 while the other end of the piston is housed within the hydraulic cylinder 34 that is attached to the side of the outside side member panel 24. The hydraulic piston and cylinder are conventional in their construction and are operated by the pressure of hydraulic fluid controlled by valves. The controls for the hydraulic system are located in the cockpit of the bulldozer (not shown). Appropriate application of the hydraulic controls will cause the piston 32 to extend out of the cylinder 34 and force the movable plate 28 downwardly and partially out of the side member housing 20. This movement of the plate 28 causes the end member 20 and the left end of the blade 10 to be raised with respect to the skid 30 (FIG. 2B). With opposite adjustment of the hydraulic controls the piston 32 is made to retract into the cylinder 34, thus lowering the elevation of the blade 10 with respect to the skid 30 (FIG. 2A). While hydraulic apparatus is the preferred form of motive force, other well known means may be employed that provide sufficient downward pressure on the skids 30 and keep the bottom of the blade at the right height above the base grade 16.

While a single hydraulic piston may be sufficient to supply the power to raise and lower the blade end, a single piston may be structurally unstable. To overcome the instability a tubular sleeve 40 is attached to the outside side member panel 24 and the distal end of a slidable insert 42 is attached to the skid 30. Thus, while the hydraulic piston and cylinder are supplying the necessary force to move the plate 28 within the end member, the sleeve and slidable insert supply the required structural stability between the movable members.

To ensure that the skid 30 remains in solid contact with the base grade 16 an auxiliary plow 46 is angularly attached to the front of each skid 30. The plow is angled inwardly toward the blade 10 so that the material being spread will not collect in front of the skid 30 so as to pass beneath the skid and upset the precision of the height adjustment of the blade 10.

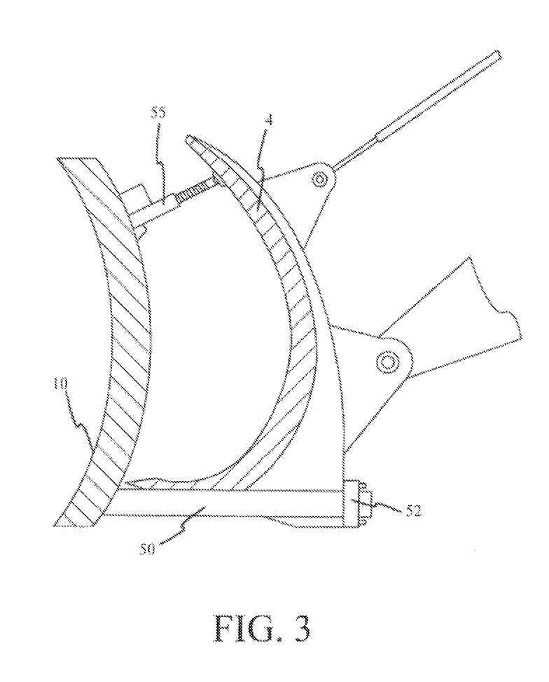

As seen in FIGS. 2A and 3 the bottom of the bulldozer blade 4 rests on the top surface of a plurality of rearwardly protruding brackets 50. In one embodiment, a stop 52 carried by the bracket is screwed against the back of the bulldozer blade 4 to hold the bulldozer blade in place against the grader blade 10. Between the top portion of the bulldozer blade and the top of the back side of the grader blade a jack screw 55 provides a compression connection between the two blades. Adjustment of the jack screw operates to establish the tilt of the grader blade.

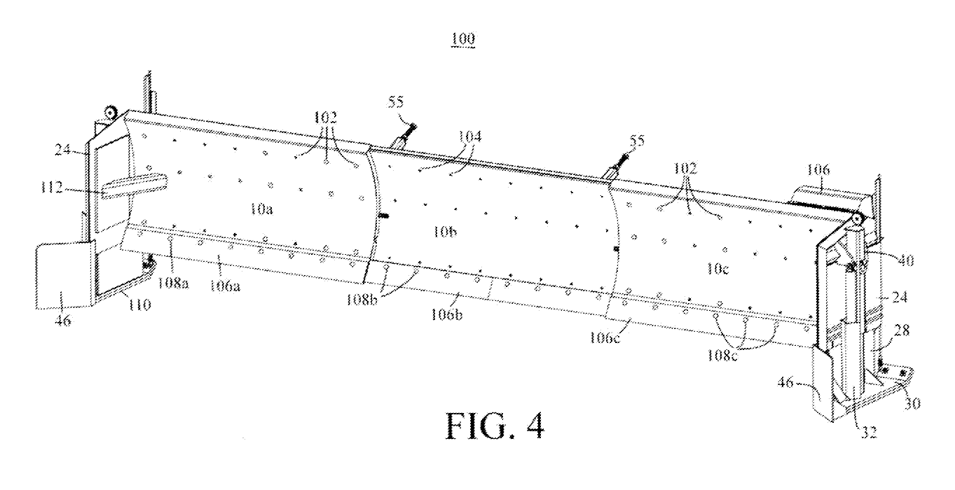

FIG. 4 is a top right perspective view of the front of an expandable grader attachment 100 in accordance with one embodiment of the invention. The expandable grader attachment 100 is similar to that shown in FIGS. 1-3, but is expandable. This embodiment of the expandable grader attachment 100, has a blade made of three portions 10a, 10b, 10c. The outer portions 10a & 10b have a number of adjustment holes 102 that align with the adjustment holes 104 of the center portion. Bolts and nuts are used to lock the three portions of the expandable blade 10a, 10b, 10c together. Slides or other forms of holding the blade portions 10a, 10b, 10c together are not rigid enough to produce a high quality gravel road surface. This figure also shows that the hydraulic pump 106 is mounted to the backside of the expandable grader blade 100. The hydraulic pump 106 connects electrically 116 to a bulldozer's electrical system and provides the hydraulic power to hydraulic cylinders and pistons 32. Each blade portion 10a, 10b, 10c has an adjustable crown plate 106a, 106b, 106c. The crown plates 106a, 106b, 106c have slots 108a, 108b, 108c that align with holes in the blade portion 10a, 10b, 10c. Bolts are loosened to change the position crown plates 106a, 106b, 106c and then tightened to hold them in place. These adjustable crown plates 106a, 106b, 106c allow the expandable grader blade 100 to contour the gravel road to have a custom crown.

The skids 30 are equipped with replaceable wear pads 110. Since the skids 30 ride on the base grade they wear out over time. The wear pads 110 are designed to be replaced. The outer portions of the expandable blade 10a & 10b have braces 112 that connect the blade portion to plate 24. This add stability to the system 100.

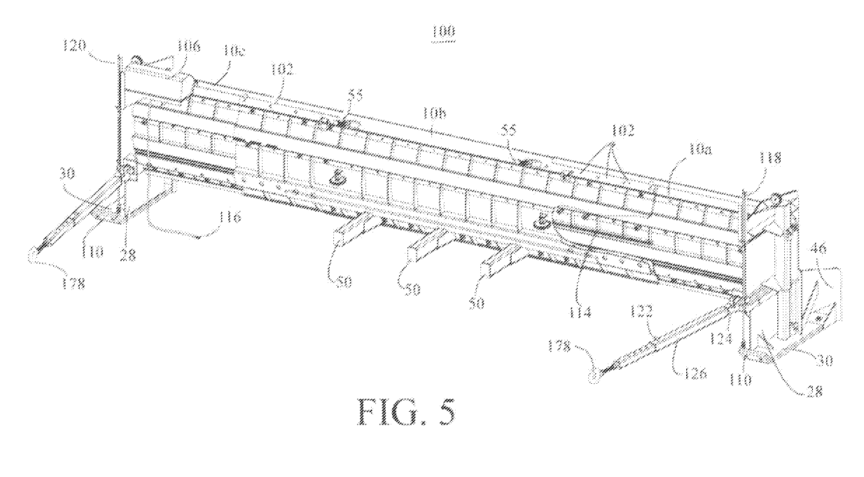

FIG. 5 is a top back perspective view of the front of the expandable grader attachment 100 in accordance with one embodiment of the invention. This view shows that the expandable blade has a rack and pinion system 114 that is used to expand or contract the size of the expandable blade 10a, 10b, 10c. Once the expandable blade 10a, 10b, 10c is in the desired position, then the blade portions are bolted together for stability. This view also shows the electrical cord 116 that connects to the bulldozer's electrical system. The plurality of rearward protruding brackets 50 are shown in this view. A pair of height gages 118, 120 allows the operator of the bulldozer to view the depth of the gravel 14. Note the height of each side of the expandable grader blade can be set separately. A pair of stability arms 122 (only one is shown) has a pintle hitch 124 connecting to the grader blade 10. An expandable arm 126 has a number of preset lengths and a screw for finer adjustments of the length. A second pintle hitch 128 attaches to a bulldozer. The stability arms provide bracing to the side blades when they are extended beyond a certain point, since the structure will have increase leverage loads toward the ends of the side blades when the side blades are extended.

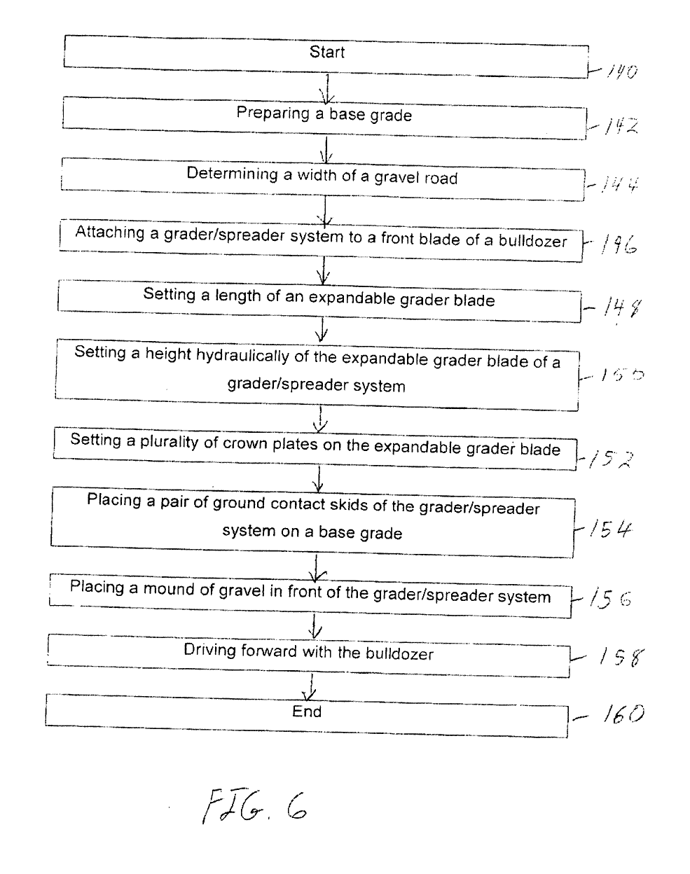

FIG. 6 is a flow chart of the steps of creating a gravel road in accordance with one embodiment of the invention. The process starts, step 140, by preparing a base grade at step 142. A width of the road is determined at step 144. A grader/spreader system is attached to the front blade of a bulldozer at step 146. A length of the expandable grader blade is set at step 148. A height of the expandable grader blade is set hydraulically at step 150. A plurality of crown plates are set on the expandable grader blade at step 152. A pair of ground contacting skids of the grader/spreader system are placed on the base grade at step 154. A mound of gravel is placed in front of the grader/spreader system at step 156. At step 158, the bulldozer is driven forward which ends the process at step 160.

Using the system described herein an accurate depth of gravel is laid on the base grade in a single pass without any rework being necessary. The system does not require blue tops, associated surveying costs, or multiple passes like previous techniques of laying down an accurate gravel road. Accurate depth of the gravel road is accomplished by the down pressure applied from the bulldozer through the hydraulic cylinders 32. The front blade of the bulldozer rests on the brackets 50 and applies down pressure on the expandable grader blade. The pitch screws 55 set the pitch of the expandable grader blade. By setting these so that the grader blade is pitched forward, additional down pressure is created as the bulldozer moves forward. It is important that the bulldozer push the grader blade as this creates a down pressure that cannot be created by pulling the grader blade and allows the bulldozer tracks to ride on the finished grade. The finish grade is level, while the base grade may have some non-uniformity. If the bulldozer tracks rode on the base grade these non-uniformities would translate into non-uniformities in the finish grade. In one embodiment, the invention is attached to a tracked skid steer instead of a bulldozer.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and in variations in the appended claims.

1. A road grader/spreader system, comprising:
an expandable grader blade;
a plurality of rearward protruding brackets attached to a backside of the expandable grader blade on top of which a front blade of a bulldozer rests;
a pair of ground contacting skids;
a pair of hydraulic pistons and cylinders connecting the pair of ground contacting skids to the expandable grader blade; and
a pair plow plates attached to a front end of the pair of ground contacting skids.

2. The system of claim 1, further including a hydraulic pump mounted to the backside of the expandable grader blade, the hydraulic pump having an electrical cord to easily connected to a bulldozer's electrical system.

3. The system of claim 1, further including a height gage attached to an end and the backside of the expandable grader blade.

4. The system of claim 1, wherein the grader blade is composed of three sections and has a rack and pinion slide connecting a first section and a second section.

5. The system of claim 4, wherein the three sections of the grader blade include a plurality of holes for receiving a plurality of bolts.

6. The system of claim 1 further including a pair of adjustable side braces that connect between a bulldozer arm and the expandable grader blade.

7. The system of claim 1, further including a plurality of pitch screws attached to the back of the expandable grader blade.

8. The system of claim 1, further including a replaceable wear pad attached to a bottom of the ground contacting skids.

9. The system of claim 1, wherein a lower portion of the grader blade has a plurality of adjustable plates.

10. A method of preparing a gravel road, comprising the steps of:
preparing a base grade;
determining a width of a gravel road;
attaching a grader/spreader system to a front blade of a bulldozer;
setting a length of an expandable grader blade;
setting a height hydraulically of the expandable grader blade of a grader/spreader system;
setting a plurality of crown plates on the expandable grader blade;
placing a pair of ground contact skids of the grader/spreader system on a base grade;
placing a mound of gravel in front of the grader/spreader system; and
driving forward with the bulldozer.

11. The method of claim 10, wherein the step of attaching the grader/spreader system includes the step of setting a pair of pitch screws.

12. The method of claim 10, wherein the step of setting a length, includes the step of determining half the width of the gravel road.

13. The method of claim 10, wherein the step of setting the plurality of crown plates includes the step of determining a required crown for the road.

14. A road grader for mounting to a bulldozer blade and being pushed by a bulldozer comprising,
an elongated grader blade having a horizontal longitudinal axis and front and front and back sides with lateral ends and,
two mutually parallel side members attached to the respective lateral ends of the blade perpendicularly to the blade's longitudinal axis, each of said side members comprising a pair of spaced apart walls,
a mounting plate having a lower edge and being slidably disposed between the spaced apart walls in each side member,
ground contacting skids riding on a base grade each having forward and rear ends and a longitudinal axis, said skids attached respectively to the lower edges of the mounting plates where the longitudinal axis of each skid is perpendicularly oriented to the longitudinal axis of the glade, and
reciprocating means interconnecting each side member with its respective mounting plate ground contacting skid for moving the mounting plate and skid up and down within the side member.

15. The assembly of claim 14 and further including a plow plate attached to the forward end of each skid and disposed at an angle to the longitudinal axis of the skid.

16. The assembly of claim 15 and further including stabilizing means interconnecting each side member with its respective reciprocating means skid.

17. The assembly of claim 14 and further including means attached to the back side of the blade for mounting the grader blade to the front blade of a bulldozer.

18. The assembly of claim 17 where the means for mounting the grader blade includes,
at least two rearwardly extending brackets disposed on the back side of the grader blade for supporting the bulldozer blade, and
at least one adjustable length pressure rod extending rearwardly from the back side of the grader blade.
